(19) United States
(12) Patent Application Publication
(10) Pub. No.: US 2012/0298707 A1
(43) Pub. Date: Nov. 29, 2012

(54) ADJUSTABLE TRUNK RACKS FOR CARRYING BICYCLES

(75) Inventors: Chris Sautter, Portland, OR (US); James Buckroyd, Portland, OR (US); Richard Jeli, Milwaukie, OR (US); Lyle Ramsdale, Lake Oswego, OR (US)

(73) Assignee: Yakima Products, Inc., Beaverton, OR (US)

(21) Appl. No.: 13/356,540

(22) Filed: Jan. 23, 2012

Related U.S. Application Data
(60) Provisional application No. 61/434,952, filed on Jan. 21, 2011.

(51) Int. Cl. B60R 9/10; B23P 11/00; B60R 9/06

(52) U.S. Cl. 224/502; 224/510; 29/428; 224/495

(57) ABSTRACT

Carriers for a bicycle and methods of mounting a bicycle carrier to a vehicle are disclosed. In some examples, the carriers may include a first frame structure configured to couple to a vehicle and a second frame structure configured to couple to the vehicle. The carriers may additionally include a body disposed between the first and second frame structures. The first frame structure may be mounted to the body and the second frame structure may be slidably received within the body. The carriers may further include a first cable device. The first cable device may include a first cable reel rotatably mounted to the body, and a first cable having a first hook end portion configured to attach to a first portion of the vehicle. The first cable may be configured to be wound around the first cable reel.

### CROSS-REFERENCE TO RELATED APPLICATIONS

This application claims priority under 35 U.S.C. §119(e) to U.S. Provisional Patent Application Ser. No. 61/434,952 filed on Jan. 21, 2011 and entitled “Adjustable Cable Mounted Trunk Rack for Carrying Bicycles.” The complete disclosure of the above-identified patent application is hereby incorporated by reference for all purposes.

This application incorporates by reference for all purposes the complete disclosures of the following U.S. patents and patent application publications: U.S. Pat. Nos. 4,109,839; 4,182,467; 4,394,948; 5,056,700; 5,495,970; 5,645,202; 6,345,748; 6,502,729; 6,840,418; 7,404,504; 2002/0117524; 2006/0060623; 2006/0138186; and 2010/0127031.

### FIELD

This disclosure relates to racks for carrying cargo items (such as bicycles), particularly adjustable racks configured for mounting on the rear of a vehicle, such as on or near a vehicle's trunk or rear hatch.

### BACKGROUND

There are many types of racks for securing cargo items, such as bicycles, to a variety of vehicles. For example, there are racks for carrying bicycles on top or at the rear of a car, in the bed of a pick-up, at the front of a bus, etc. Many bicycle racks for a vehicle are relatively large and may lack adjustability for a wide variety of vehicle shapes and sizes. In other cases, the racks, even if adjustable, may be cumbersome and difficult to handle during the adjustment process. Thus, there is a need for highly adjustable bicycle racks or carriers that are easy to adjust over a wide range of vehicle-accommodating sizes.

### BRIEF SUMMARY

An example of a carrier of a bicycle may include a first frame structure configured to couple to a vehicle and a second frame structure configured to couple to the vehicle. The carrier may additionally include a body disposed between the first and second frame structures. The first frame structure may be mounted to the body and the second frame structure may be slidably received within the body. The carrier may further include a first cable device. The first cable device may include a first cable reel rotatably mounted to the body, and a first cable having a first hook end portion configured to attach to a first portion of the vehicle. The first cable may be configured to be wound around the first cable reel.

An example of a method of mounting a bicycle carrier to a vehicle may include placing a first frame structure, a second frame structure, and a body disposed between the first and second frame structures of the carrier in a preliminary configuration relative to the vehicle. The method may additionally include slidingly translating one of the first and second frame structures relative to the other frame structure and the body to place the carrier in a configuration approximating a final configuration. The method may further include extending at least one cable having a hook end portion from at least one cable reel of the body, and attaching the hook end portion to a portion of the vehicle to fix the carrier in the final configuration.

An example of a carrier for a bicycle may include a first frame structure having first and second end portions. The first end portion may be configured to couple to a vehicle. The carrier may additionally include a second frame structure having third and fourth end portions. The fourth end portion may be configured to couple to the vehicle. The carrier may further include a body connecting the second end portion of the first frame structure and the third end portion of the second frame structure. At least one of the second and third end portions may be movably connected to the body. The carrier may additionally include a first cable device. The first cable device may include a first cable spool rotatably mounted to the body, and a first cable having a first hook end portion configured to attach to a first portion of the vehicle. The first cable may be configured to be received on the first cable spool. The carrier may further include a second cable device. The second cable device may include a housing mounted adjacent to the first end portion and spaced from the second end portion of the first frame structure. The second cable device may additionally include a second cable spool rotatably mounted to the housing, and a second cable having a second hook end portion configured to attach to a second portion of the vehicle different from the first portion. The second cable may be configured to be received on the second cable spool.

### BRIEF DESCRIPTION OF THE DRAWINGS

FIG. 1 is a perspective view of an example of a bicycle carrier configured for mounting on the rear of a vehicle.

FIG. 2 is a side view of the bicycle carrier of FIG. 1.

FIG. 3 is a rear view of the bicycle carrier of FIG. 1, mounted behind a vehicle.

FIG. 4 is a partial perspective view of the bicycle carrier of FIG. 1.

FIG. 5 is a partial perspective sectional view of the bicycle carrier of FIG. 1.

FIG. 6 is a partial cross-sectional view of an example of a clamping mechanism used on the bicycle carrier of FIG. 1.

FIG. 7 is a partial cross-sectional view of another example of a clamping mechanism which may be used on the bicycle carrier of FIG. 1.

FIGS. 8-11 are perspective views of other examples of the bicycle carrier of FIG. 1.

FIG. 12 is a perspective view of an example of a security strap for linking the bicycle carrier of FIG. 1 or a cargo item to a locked vehicle.

FIG. 13 is a cross-sectional view of the security strap shown in FIG. 12.

FIGS. 14-15 are perspective views of the security strap of FIG. 11 in use.

FIG. 16 is a perspective view of another example of a bicycle carrier configured for mounting on the rear of a vehicle, shown without bicycle restraint devices.

FIG. 17 is a side view of the bicycle carrier of FIG. 16.

FIG. 18 is a partial exploded view of an example of an upper cable device of the bicycle carrier of FIG. 16.

FIG. 19 is a partial exploded view of an example of a lower cable device of the bicycle carrier of FIG. 16.

FIG. 20 is a perspective view of an example of an arm of the bicycle carrier of FIG. 16.

FIG. 21 is an exploded view of the arm of FIG. 20.

### DETAILED DESCRIPTION

Bicycle carriers, as described below, are configured to allow a wide range of positions of the carrier's legs, allowing fit of the carrier to many vehicle sizes and styles. For example, the carrier may as easily be fit to a vehicle having a trunk, as to a vehicle having a hatch back or even a substantially flat back (such as a minivan). To allow the carrier to fit on many types and sizes of vehicles, the carrier may, for example, have an arcuate profile, arising from its use of legs whose shapes define a substantially semicircular path. The legs may be configured to slide past each other, either at a defined spot (for example, if the legs slide past each other at an intersection point) or over a defined path (for example, if one leg slides within the housing of another; i.e. the legs “telescope”).

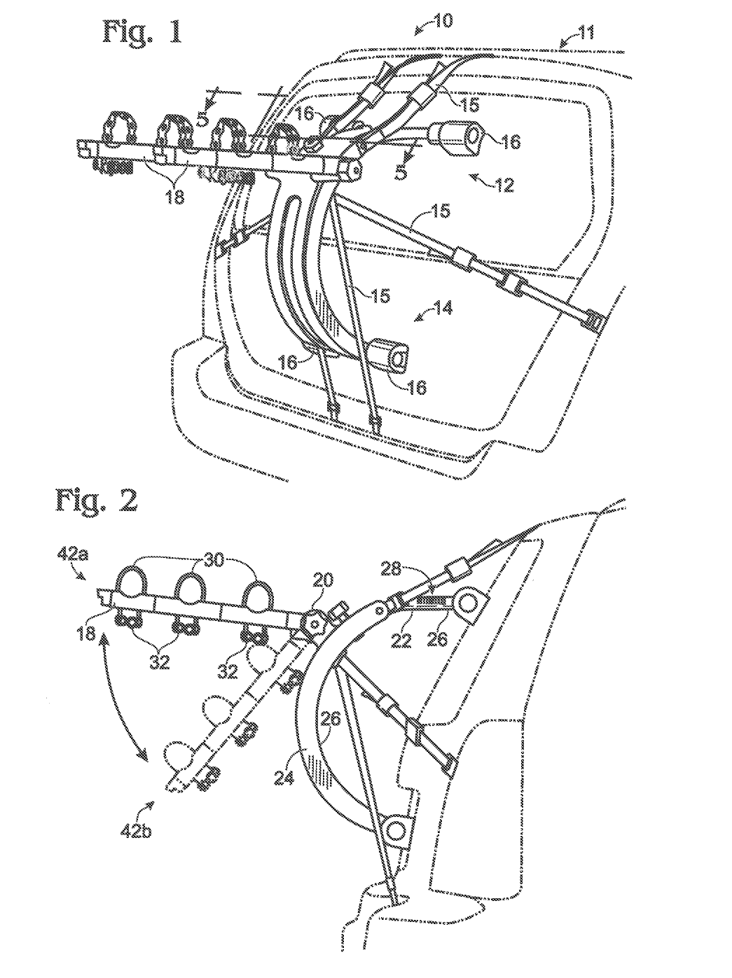

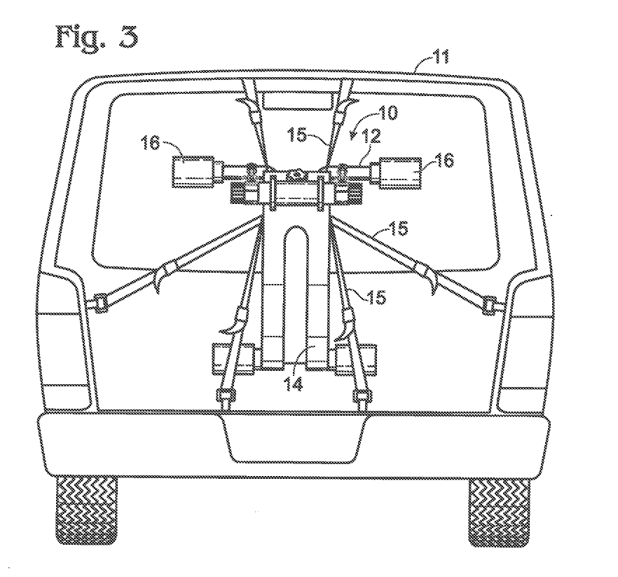

FIGS. 1-3 show perspective, side, and rear views, respectively, of one embodiment of a rack or bicycle carrier 10 configured for and mounted to the rear of a vehicle 11. The bicycle carrier 10 may contact the vehicle 11 by means of the carrier's first frame element 12 and second frame element 14. The frame elements may also be described as the “legs” of the carrier. Frame elements 12, 14 of the carrier may include frame feet 16, which may function to protect the surface of the vehicle from abrasion that could be caused by the frame elements 12, 14 of the bicycle carrier 10. The carrier may be stabilized in position on the vehicle 11 by one or more straps 15.

Bicycle carrier 10 may include one or more arms 18 configured to support one or more bicycles (not shown) on the vehicle. Each of arms 18 may be coupled to the first or second frame element (or both, depending on the design of the carrier) at shoulder 20. Each shoulder 20 may be configured to allow its attached arm 18 to be reversibly fixed at a variety of angular positions relative to other parts of the bicycle carrier. For example, each arm 18 may be set to an angular position 42a, or it may be set to an angular position 42b, or it may have any other appropriate angular position with respect to other elements of the bicycle carrier. Each of arms 18 may be set to the same angular position, or they may be set to different angular positions, as required by the needs of a user.

As seen in FIGS. 1-2, first frame element 12 may have a first body 22 and the second frame element 14 may have a second body 24. Each of the first and second bodies 22, 24 may be a tubular member 26 (with “tubular” meaning that the element has a hollow opening along a substantial portion of its length). Alternatively, one or the other, or both, of the first and second bodies may be substantially or completely solid, so long as the complete bicycle carrier 10 maintains its ability, as described below, to be reversibly adjustably fitted to a vehicle 11.

One or the other, or both, of first and second frame elements 12, 14 may include measurement markings 28 that may be used for accurately positioning frame elements 12, 14 relative to each other. The measurement markings may be printed on the element having the marks, or they may be engraved on a surface of the element, or otherwise appropriately be fixed to the element. In the illustrated embodiment, frame elements 12, 14 are in a sliding relationship (described below), and the measurement markings are arranged so that they indicate the relative sliding position of the first and second frame elements 12, 14. Allowing repeatable accurate positioning of the elements when the carrier is removed from and placed onto a vehicle makes for more efficient use of the carrier.

As mentioned above, the bicycle carrier may include one or more arms 18 configured to carry one or more bicycles (not shown). FIGS. 2 and 4 show that each arm may be configured to carry bicycles in bicycle restraint devices 30 in association with anti-sway or stabilizer elements 32. Bicycle restraint devices 30 and anti-sway elements 32 may keep a bicycle from experiencing excessive movement when it is carried in a trough or saddle 34 on an arm 18, or on another portion of the arm, and the carrying vehicle is in motion. Typical restraint and anti-sway devices, and their function, are described in U.S. Pat. No. 6,286,738, the complete disclosure of which is incorporated herein by reference for all purposes.

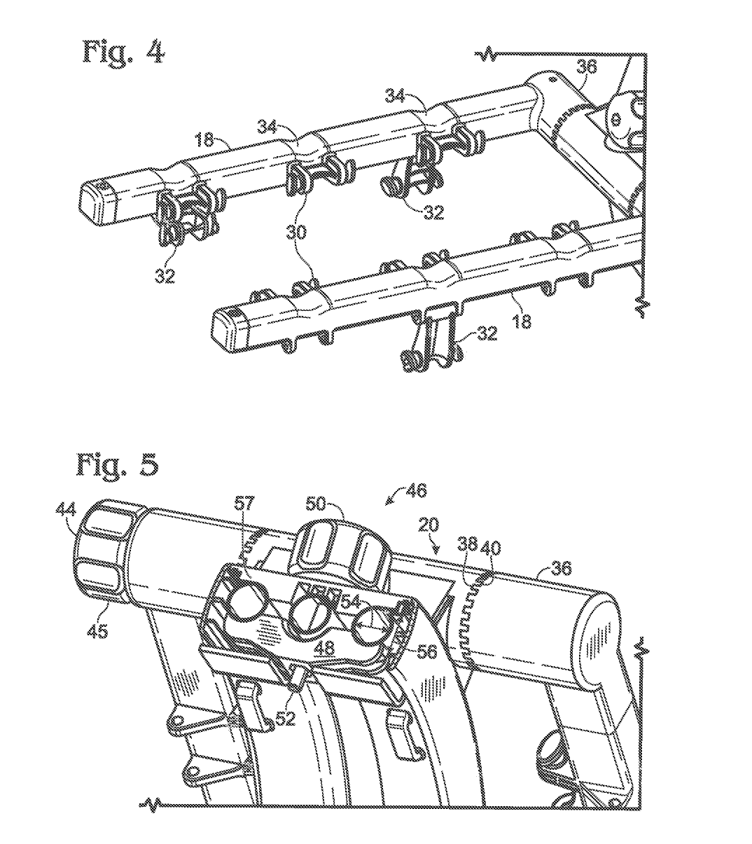

FIGS. 4-5 show partial perspective views of the bicycle carrier embodiment shown in FIG. 1. As seen in the Figures, proximal end 36 of arm 18 may couple to shoulder 20 of the carrier. Shoulder 20 and proximal end 36 of arm 18 may meet at castellated surfaces 38 and 40 of the shoulder and arm, respectively. The castellated surfaces may provide an interlocking or meshing interaction between the shoulder and arm such that the arm can be held at discrete angular positions 42a, 42b (shown in FIG. 2) relative to the shoulder. Although each surface is depicted as having a square-wave profile, any appropriate profile that allows discrete positioning and locking of the arm and shoulder is possible. For example, the surfaces could have a sine-wave profile, or a more complex profile. In addition, the profile of the castellated surface may be designed with any desired level of detail. For example, the surface may include relatively few “notches” with which to fix an angular position, providing fewer potential angular positions, or the surface may include a large number of “notches,” providing much finer angular positioning of the arms.

Typically, the castellated surfaces 38, 40 of the shoulder and arm can be reversibly tightened into and out of a close meshing relationship. To provide reversible tightening of the interacting surfaces, the carrier may be equipped with arm fixation mechanism 44. The arm fixation mechanism may be configured as shown in FIG. 5. Mechanism 44 may include tightening knob 45 coupled to a proximal end of an extended rod or bolt (not shown) which traverses the shoulder region 20 of the carrier. The proximal end of the bolt may thread through a proximal end of a first arm while the distal end of the bolt may be threaded into the proximal end of a second arm. In this way, when the bolt is screwed into the proximal end of the second arm, the bolt may “squeeze” the entire shoulder-and-arm assembly together, securing the interaction of the castellated surfaces and substantially fixing the relative positions of arms 18 and shoulders 20. Alternatively, the bolt may be screwed out of the proximal end of the second arm “relaxing” the fit of the entire shoulder-and-arm assembly and allowing freer relative movement of the arms and shoulders. An internal spring device (not shown) may be used to bias complimenting teeth to disengage when the fixation mechanism is loosened.

In addition to including an arm fixation mechanism 44 for fixing the angular position of arms 18 relative to shoulder 20 of the frame, bicycle carrier 10 may include a slide restriction mechanism 46 for reversibly fixing the relative position of frame elements 12, 14 to accommodate a particular trunk or hatch profile of a vehicle. The slide restriction mechanism shown in FIG. 5 (cross-sectional view through rack in FIG. 1) includes clamping member 48 that can be reversibly held against one or both of the frame elements upon manipulation of tightening knob 50. The tightening knob, when rotated, may operate on a tightening screw or bolt 52 that threads into a portion of clamping member 48.

Turning tightening knob 50 and, thus, bolt 52 in the appropriate direction may cause clamping member 48 to “squeeze” one of the first and second frame elements against the other. In this way, the slide restriction mechanism may restrict the sliding interaction between the frame elements. In the illustrated embodiment, for example, the first frame element may have a tubular element body having an outer element diameter 54, while the second frame element may have a tubular element body having an inner element diameter 56. The inner element diameter 56 may be defined by the spacing between the clamping member 48 and an inner wall 57 of the second frame element.

In a configuration where the first and second elements are able to relatively freely slide past each other, diameter or gap 56 is greater than diameter 54. To restrict sliding of the frame elements, tightening knob 50 and bolt 52 are turned in a way that causes clamping member 48 to move toward inner wall 57 of the second frame element. As gap 56 approaches the value for diameter 54, sliding of the first and second frame elements 12, 14 will become progressively more difficult until eventually the elements are frictionally fixed. At this point (where a sufficient amount of tightening is achieved to maintain a desired spatial relationship between the frame elements when they are carrying bicycles on a vehicle) the frame elements may be described as “fixed” or “locked” into position.

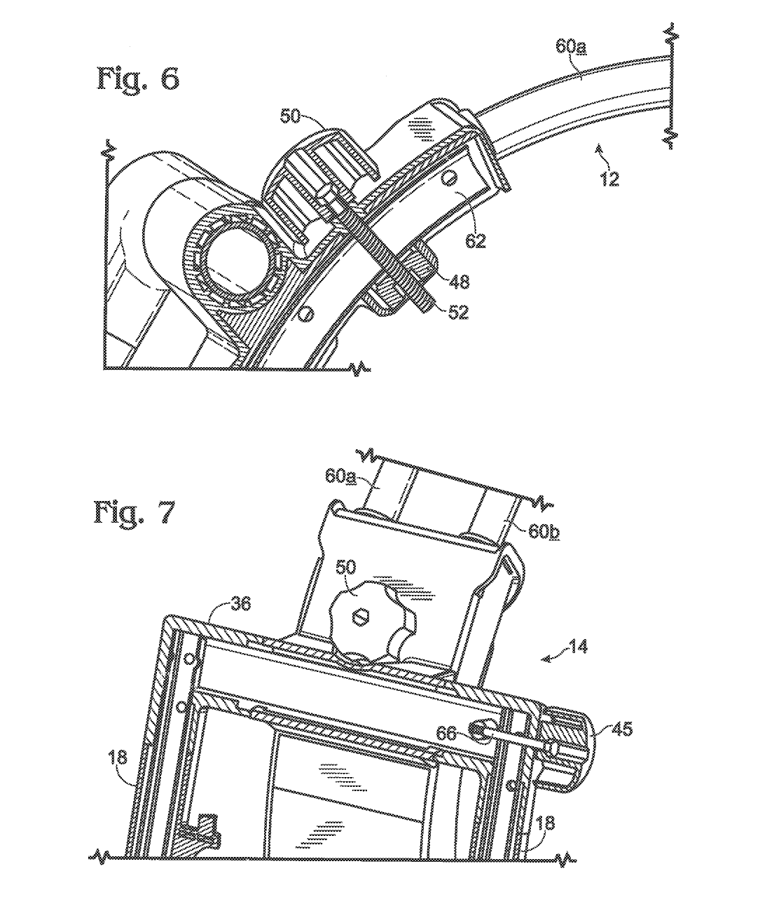

FIG. 6 shows a cross-sectional view through slide restriction mechanism 46 of rack 10. First frame element 12 has a pair of arcuate parallel bars 60a, 60b engaging second frame element 14, as previously described and shown in FIG. 5. Second frame element 14 has central arcuate tube member 62. Bolt 52 passes through second frame element 14, specifically through tube member 62 in a direction perpendicular to a tangent of tube member 62. Knob 50 is connected to bolt 52 such that rotation of knob 50 causes bolt 52 to rotate and effectively tighten or pull clamping member 48 into a clamping position with respect to bars 60a, 60b of first frame element 12.

FIG. 7 shows a cross-section through the locking device for permitting selective adjustment of position of arms 18 relative to first and second frame elements 12, 14. Generally, adjustment of arms 18 relative to first and second frame elements 12, 14 is performed after relative adjustment of the first and second frame elements has been completed and fixed relative to a specific vehicle trunk or hatch configuration. Knob 45 is connected to bolt 66 and is operable for allowing manipulation, i.e., rotation of bolt 66 to achieve tightening or loosening of shoulder 20, as previously described.

As an alternative to the described tightening systems (for both the arm fixation and slide restriction mechanisms), the movable elements could be fixed in place using a mechanism that assigns discrete relative positions to the elements, such as a pawl and ratchet system. Other tightening systems are possible that would allow, alternatively, free adjustability and substantial fixation of the frame elements. For example, the mechanism could use an over-center latch coupled to a tightening element.

Having described the operative features of an embodiment of a bicycle carrier, there follows a description of a way in which it may be used. To fit a carrier to a vehicle, a user may initially place one or more of feet 16 of the first and second frame elements 12, 14 against the vehicle; this may involve resting foot 16 of the element against a trunk or back surface of the vehicle. The user may then ensure that the slide restriction mechanism 46 of the carrier is loosened sufficiently to allow relatively free sliding movement between the first and second frame element bodies 22, 24. Alternatively, the user may perform this step before placing the frame element against the vehicle.

The user may next determine the correct relative position for the “free” frame element (the one whose associated foot is not yet positioned against the vehicle). To do this, the user may slide the body of the free frame element relative to the body of the first frame element until the foot coupled to the free frame element contacts or is otherwise coupled to the vehicle. For example, assume for the moment that the user initially placed the foot of the second frame element 14 against the vehicle. The user could relatively easily hold that frame element in place while simultaneously sliding the first frame element 12 relative to the second frame element 14 (e.g. while the user slides the first frame element body 22 out of the tubular portion of the second frame element body 24). In embodiments where the frame elements and/or the element bodies are arcuate and tubular, the user may slide the second frame element body 24 along an arcuate path until the first frame element 12 (or an associated foot 16) contacts the vehicle in a desired location. This type of adjustment can be described as a “telescoping” adjustment mechanism.

In essence, the user adjusts the described bicycle carrier by sliding the frame elements 12, 14 relative to each other until the appropriately-sized semicircular structure for a given vehicle is formed. Upon configuring the bicycle carrier with the appropriately-sized frame for mounting to a given vehicle location, the user can fix the carrier to the desired size by tightening the slide restriction mechanism 46 or other fixation mechanism to prevent further sliding of the legs relative to each other.

For more secure fixation to a vehicle, the user may couple the carrier to various portions of the vehicle through the use of straps 15. In some situations, the user may first configure the carrier and then affix the straps to the vehicle. In other situations, however, the user may attach the straps to the vehicle before final configuration of the frame elements is performed (i.e. when the frame is “roughly” the right size), only fixing the final relative position of the frame elements after the straps have been put into place.

Finally, the user may position the arms 18 of the carrier to the correct angular position for carrying one or more bicycles on the vehicle. Of course, though shown as an embodiment of a bicycle carrier, the described adjustable frame elements could be used with arms configured to carry other types of sporting goods, work tools, or accessories, as a user may desire. The arms may also be equipped with different combinations of saddles and stabilizers for carrying bikes. The user may release the arm fixation mechanism 44 so that relatively free movement between an arm 18 and its associated shoulder 20 is achieved. The user may then position the arm at a desired position relative to the carrier and vehicle so that a given bicycle (or other article) can be supported stably. The user may then tighten the arm fixation mechanism so that the arm and shoulder are substantially fixed in a given configuration. For most effective fixation, the user may position the arm and shoulder so that the castellated surfaces mesh together (with peaks being snugly held in valleys).

The user may note, for future mounting to the same or a similar vehicle, the relative position of the frame elements by reference to where one frame element sits relative to the measurement marks on the other. For use on a first vehicle, this could be measurement mark “A,” while for use on a second vehicle, this could be measurement mark “B.” Once the user removes the carrier from a vehicle after use, the user may release the slide restriction mechanism to collapse the carrier for storage (e.g. the user may fully telescope one frame element into the other). When the carrier is next required to be used on a given vehicle for which a measurement mark is known, the user may arrange the frame elements to an appropriate configuration before mounting the carrier to the vehicle. To do this, the user may simply move (i.e. slide) the frame elements until a reference point on the first frame element is located at the measurement mark of the second frame element that gives an appropriately sized carrier for that given vehicle. The user may then tighten the slide restriction mechanism and mount the preconfigured carrier to the vehicle.

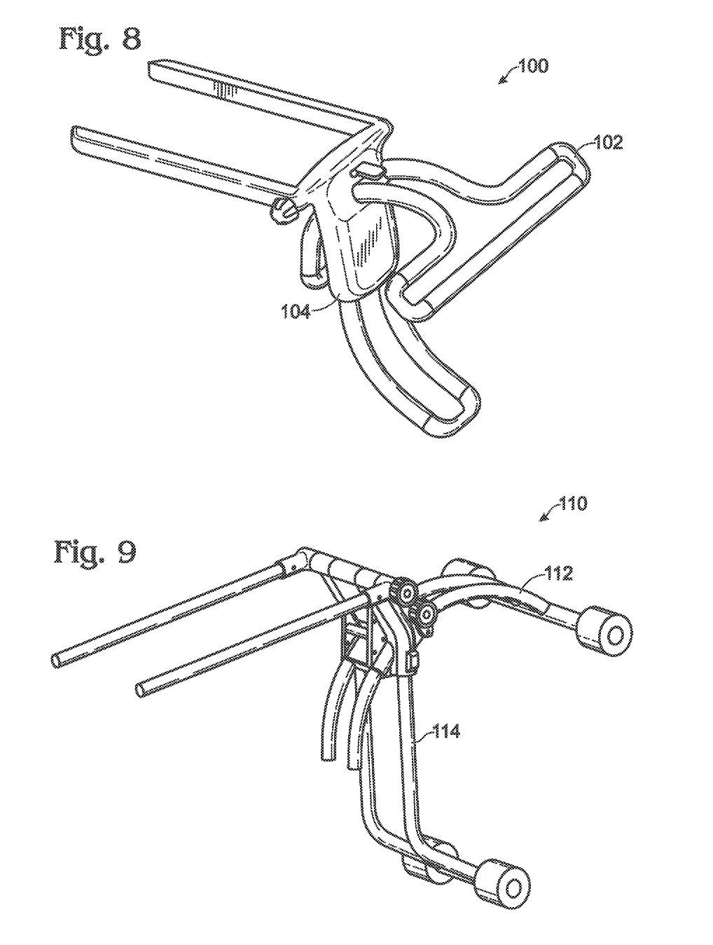

FIG. 8 shows rack 100 for carrying cargo on the rear of a vehicle. Rack 100 includes first and second frame elements 102, 104 which have arcuate tube portions, however, configured different from the frame elements previously described. First frame element 102 has a continuous key-shaped loop at one end for interfacing against a vehicle surface. The other end of first frame element 102 extends through a body portion of second frame element 104 for providing accommodation to a particular vehicle configuration. It may be assumed that the clamp devices used in rack 100 are similar to those previously described.

As shown in FIG. 9, rack 110 also uses an arcuate-shaped first frame element 112, which is slidable relative to second frame element 114. It may be assumed that the clamp devices used in rack 110 are similar to those previously described.

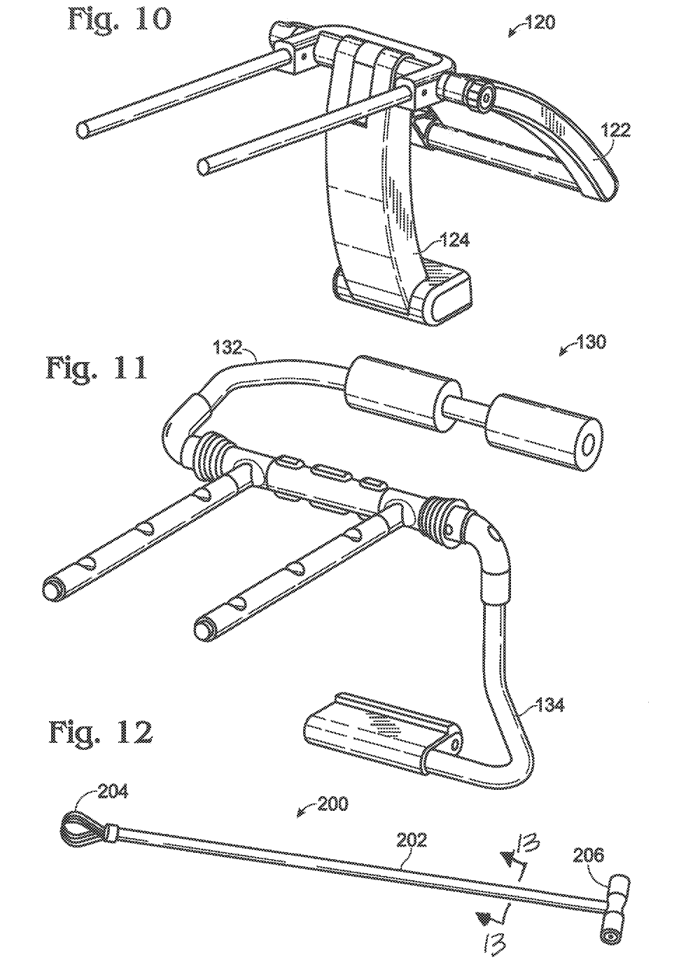

FIG. 10 shows another rack embodiment 120 including first frame element 122 coupled to second frame element 124. First frame element 122 and second frame element 124 are pivotally coupled to each other instead of using a sliding engagement mechanism for adjustment purposes. It may be assumed that the clamp devices used in rack 120 are similar to the clamp device previously described with respect to the shoulder of rack 10 in FIGS. 1-7.

FIG. 11 shows another rack configuration 130 which, similar to rack 120, uses a pivoting adjustment mechanism between first frame element 132 and second frame element 134 provide adjustment for accommodating different vehicle configurations, instead of a sliding engagement mechanism as previously described.

FIG. 12 shows cut-resistant security strap for tethering a rack or cargo item, such as a bicycle, to a vehicle. Strap 200 includes strap member 202 having looped end 204 and enlarged or toggled end 206. Toggled end 206 has an enlarged semi-rigid configuration that can be positioned inside a vehicle compartment with the strap passing through a crack or gap between, for example, a door and main vehicle body, and is large enough so it cannot be pulled through the gap.

FIG. 13 shows a cross-section through strap portion 202. Strap portion 202 includes polyester webbing 210 with embedded stainless steel wire rope strands 212a, 212b for resisting cutting. An example of a suitable wire rope includes 2×, 02/32 (2.38 mm) 302 stainless steel wire rope.

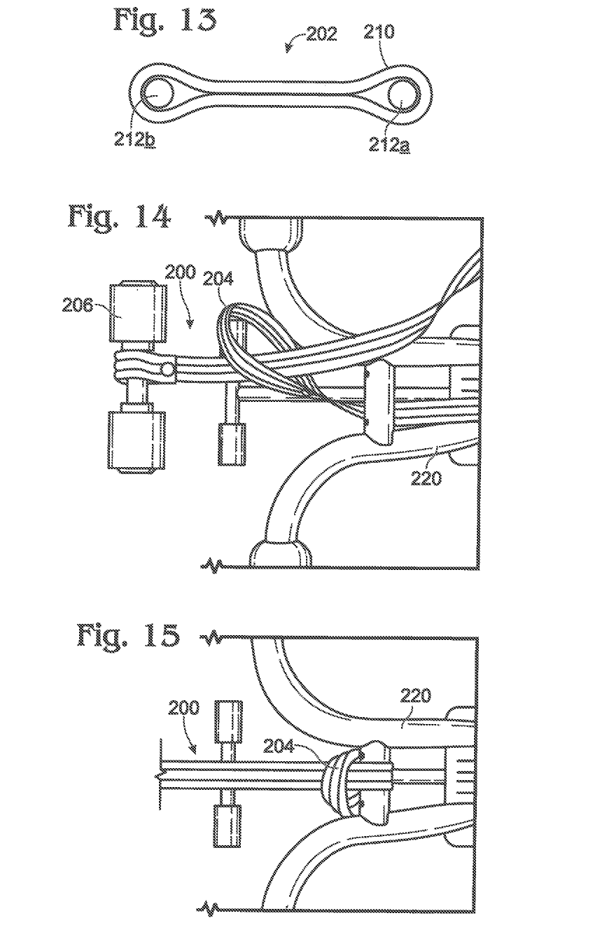

FIG. 14 shows strap 200 looped around rack 220. Toggled end 206 is threaded through loop 204. Toggled end 206 is then placed inside a compartment of the vehicle, for example, the trunk or passenger compartment, before closing the trunk, hatch, or door. The trunk, hatch or door is then closed and locked, preventing the toggled end of security strap 200 from being removed from the vehicle. FIG. 15 shows looped end 204 tensioned or tightened around rack 220.

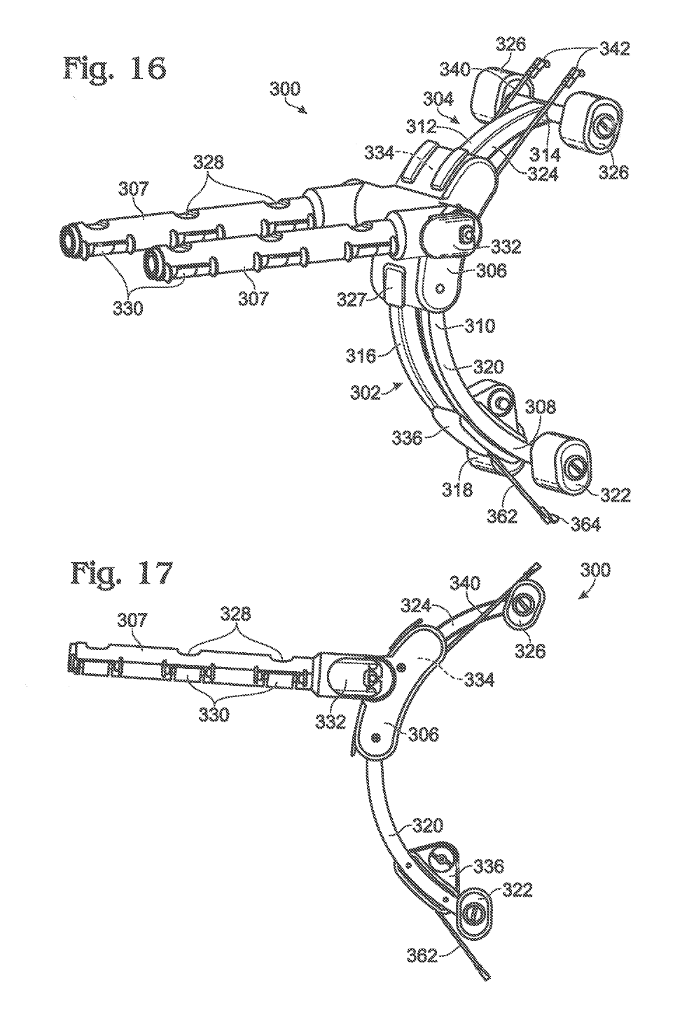

FIGS. 16-17 show perspective and side views, respectively, of another example of rack or bicycle carrier 10, which is generally indicated at 300. Rack 300 may include a first frame structure 302, a second frame structure 304, a body 306 disposed between the first and second frame structures, and at least one arm 307 movably connected to the body. First frame structure 302 may include a first end portion 308 and a second end portion 310. Second frame structure 304 may include a third end portion 312 and a fourth end portion 314. The first and second frame structures may each be configured to engage a vehicle. For example, first end portion 308 may be configured to engage a vehicle, and fourth end portion 314 may be configured to engage a higher portion of the same vehicle.

Frame structure 302 may be mounted or attached to body 306. For example, second end portion 310 may be fixedly attached to body 306. Additionally, frame structure 302 may include a first leg 316 and a first foot 318, and a second leg 320 and a second foot 322. In some examples, frame structure 302 may include only a single leg or three or more legs. Additionally, in some examples, the first and/or second legs may be movably connected to body 306, such as slidably received within the body or pivotably connected to the body.

Frame structure 304 may be movably connected to body 306. For example, third end portion 312 may be slidingly received within body 306. Additionally, frame structure 304 may include a third leg 324 and third feet 326. In some examples, frame structure 304 may include two or more legs. Additionally, in some examples, frame structure 304 may be pivotably connected to body 306 or mounted (or fixedly attached) to that body. The first, second, and/or third legs may be tubular members, or may be substantially or completely solid.

Body 306 may include any suitable structure configured to connect the first and second frame structures. For example, body 306 may be attached to second end portion 310 of first frame structure 302 and slidingly receive third end portion 312 of second frame structure 304. Body 306 may include a slide adjustment member 327 (such as a slide lever) configured, when activated, to allow a user to slide at least one of the first and second frame structures relative to the body. Additionally, body 306 may at least partially contain one or more cable devices, as further discussed below.

Arm(s) 307 may be pivotably connected to body 306 and may be configured to carry bicycles. The arm(s) may include saddles or troughs 328 and anti-sway elements 330, which may receive bicycle restraint devices (not shown). Although rack 300 is shown to include two arms 307, the rack may include any suitable number of arms, including one or three arms. Body 306 may include an arm adjustment member 332 (such as an arm lever) configured, when activated, to allow a user to pivot arm(s) 307.

Rack 300 may additionally include a first cable device 334 and a second cable device 336. The first cable device may include any suitable structure configured to attach the rack to at least a first portion of a vehicle. First cable device 334 may be at least partially contained in body 306. Second cable device 336 may include any suitable structure configured to attach the rack to at least a second portion of the vehicle. The second cable device may be mounted or attached to any suitable portion of the rack, such as adjacent to first end portion 308 and spaced from second portion 310 of first frame structure 302.

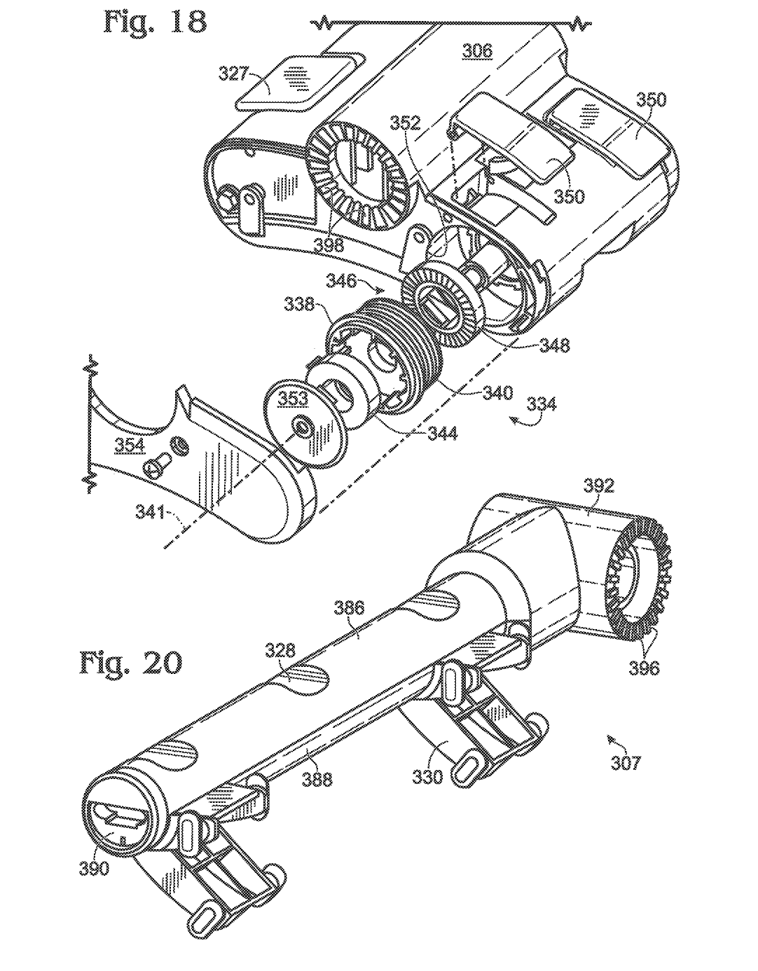

As shown in FIG. 18, first cable device 334 may include at least one cable reel (or cable spool or drum) 338 and at least one cable 340 at least partially wrapped around the spool. The cable reel may be rotatably mounted to body 306 to rotate about a first axis 341. Cable 340 may be configured to be wound around and/or received on cable reel 338. The cable may include at least one hook end portion 342 (shown in FIG. 16) configured to attach to a portion of a vehicle, such as around a body seam (e.g., front edge of a trunk or hatchback). Any suitable cable may be used, such as 3/32 inch steel with a ⅛″ nylon sleeve.

In some examples, the first cable device may include a bias element 344, such as a spiral spring or other suitable self-winding mechanism, configured to urge cable reel 338 to rotate in a direction that winds cable 340 around that cable reel. In some examples, first cable device 334 may include at least one locking mechanism 346 configured to prevent rotation of cable reel 338. For example, locking mechanism 346 may include a first locking member 348 (such as a pawl) and a first adjustment member 350 (such as a release lever). The first locking member may be configured to move between a locking position in which the first locking member contacts cable reel 338 to prevent rotation of that cable reel, and an unlocking position in which the first locking member is spaced from cable reel 338 allowing rotation of that cable reel. First adjustment member 350 may be configured to allow a user to move the first locking member between the unlocking and locking positions, such as by lifting and releasing the release lever.

First cable device 334 may be at least partially contained within body 306, such as within at least one cavity 352 with a cap 353 and/or a cover 354 maintaining the device within the cavity. First cable device 334 may include two sets of the above components, which may be contained in first and second discrete and independent cavities 352 of body 306, or may include a single set of those components. When the first cable device includes two sets, the cable reels may be rotatably mounted to the body such that the reels rotate around a common axis. Alternatively, the cable reels may rotate along different axes, such as parallel axes.

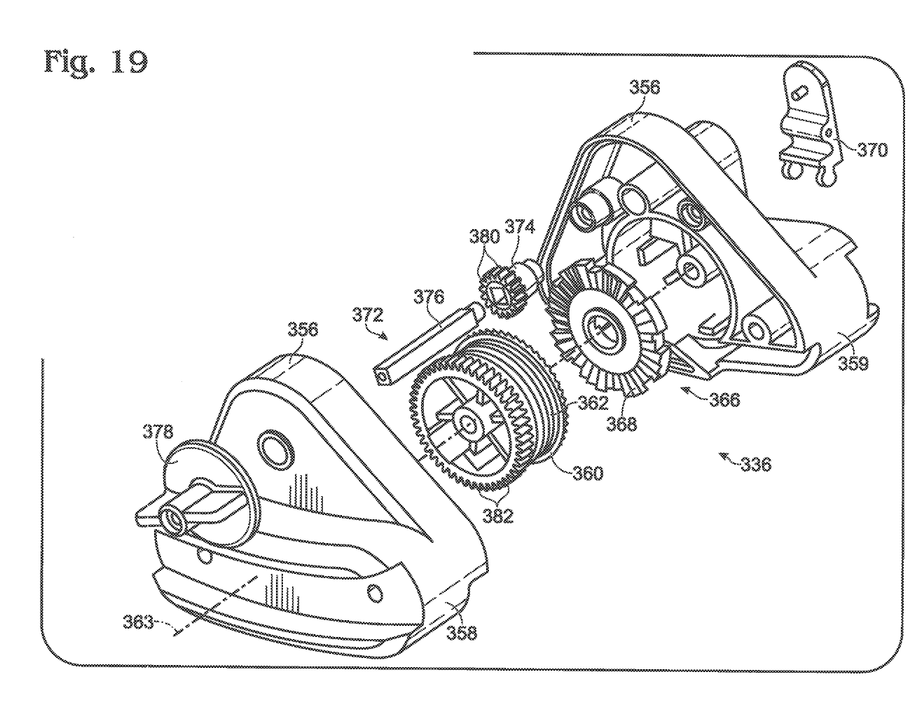

As shown in FIG. 19, second cable device 336 may include a housing 356, at least one cable reel (or cable spool or drum) 360, and at least one cable 362 variably wrapped around the spool. The housing may include first and second housing portions 358 and 359. Additionally, housing 356 may be mounted to first frame structure 302, such as on or adjacent to first end portion 308 and spaced from second end portion 310. Cable reel 360 may be rotatably mounted to housing 358 to rotate about a second axis 363. The second axis may be parallel to but spaced from first axis 341, or may have any suitable orientation relative to the first axis. Cable 362 may be configured to be wound around and/or received on cable reel 360. The cable may include at least one hook end portion 364 (shown in FIG. 16) configured to attach to a portion of a vehicle (such as a lower body seam or lower edge of a trunk). Any suitable cable may be used, such as 3/32 inch steel with a ⅛″ nylon sleeve.

In some examples, the second cable device may include at least one locking mechanism 366 configured to prevent rotation of cable reel 360. For example, locking mechanism 366 may include a second locking member 368 (such as a pawl) and a second adjustment member 370 (such as a release tab). The second locking member may be configured to move between a locking position in which the second locking member contacts cable reel 360 to prevent rotation of that cable reel, and an unlocking position in which the second locking member is spaced from cable reel 360 allowing rotation of that cable reel. Second adjustment member 370 may be configured to allow a user to move the second locking member between the unlocking and locking positions, such as by pushing and releasing the release tab.

In some examples, second cable device 336 may include an adjustment mechanism 372, which may include any suitable structure configured to allow a user to rotate cable reel 360 to adjust tension of cable 362 when hook end portion 364 is attached to a portion of a vehicle. For example, adjustment mechanism 372 may include a gear 374, an axle 376, and a knob 378. The gear may be connected to cable reel 360, such as via gear teeth 380 of gear 374 contacting gear teeth 382 of cable reel 360. Axle 376 may connect knob 378 with gear 374 such that a user may rotate gear 374 (and cable reel 360) by rotating knob 378.

Although first cable device 334 is shown to include bias element 344, the second cable device may alternatively, or additionally, include bias element 344. Additionally, although second cable device 336 is shown to include adjustment mechanism 372, first cable device 334 may alternatively, or additionally, include adjustment mechanism 372. Moreover, although rack 300 is shown to include first and second cable devices, one or more of the other racks described and shown in the present disclosure may include the first and/or second cable devices.

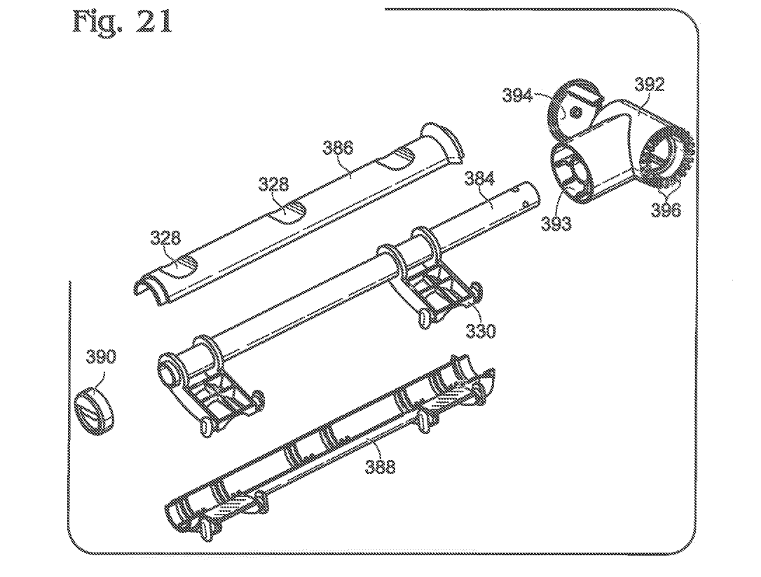

As shown in FIGS. 20-21, an example of arm 307 may include an arm tube 384, a first cover portion (or top cover) 386, a second cover portion (or bottom cover) 388, an endcap 390, and a shoulder 392. The arm tube may pivotably receive anti-sway elements 330 (equipped with straps, not shown) and may be covered by first cover portion 386, second cover portion 388, and endcap 390. The first cover portion may include cradles or saddles 328 for carrying bicycles, which may be molded into the first cover portion with elastomer overmold. Arm tube 384 and first and second cover portions 386 and 388 may be received in opening 393 of shoulder 392.

Shoulder 392 may include a shoulder cap 394 and castellated surfaces 396. The castellated surfaces may provide interlocking or meshing engagement or interaction with the castellated surfaces 398 of body 306 (shown in FIG. 18). The castellated surfaces of shoulder 392 and body 306 may be reversibly tightened into and out of a close meshing relationship, such as via an arm fixation mechanism similar to arm fixation mechanism 44 described above. For example, a user may use arm adjustment member 332 (shown in FIG. 16) to reversibly engage and tighten the castellated surfaces. Although rack 300 is shown to include arm 307, the rack may include one or more other arms described in the present disclosure.

In use, first frame structure 302, second frame structure 304, and body 306 of rack 300 may be placed in a preliminary configuration relative to the vehicle. For example, first foot 318 and second foot 322 may be placed on a bumper or any suitable portion of the vehicle. One of the first and second frame structures may be moved, such as slidingly translated, relative to the other frame structure and body 306 to place the carrier in a configuration approximating a final configuration. For example, third leg 324 and third pair of feet 326 may be slid relative to body 306 and first frame structure 302 such that it contacts a front portion of the trunk or other suitable portion of the vehicle.

A user may unlock cables 340 via adjustment members 350 and extend the cables. The hook end portions of the extended cables may be attached to different portions of the vehicle. The user may lock cables 340 via adjustment members 350. A user may unlock cable 362 via adjustment member 370 and extend the cable. The hook end portion of the extended cable may be attached to a portion of the vehicle different from the above portions. The user may adjust tension in cable 362 via knob 378 and may lock cable 362 via adjustment member 370 to fix the carrier in the final configuration. Although an example of a method of mounting rack 300 is described above, other examples of mounting rack 300 (or other racks in the present disclosure) may add to, omit, and/or modify one or more of the above steps.

The various structural members disclosed herein may be constructed from any suitable material, or combination of materials, such as metal, plastic, nylon, plastic, rubber, or any other materials with sufficient structural strength to withstand the loads incurred during use. Materials may be selected based on their durability, flexibility, weight, and/or aesthetic qualities.

Although the present disclosure has been provided with reference to the foregoing operational principles and embodiments, it will be apparent to those skilled in the art that various changes in form and detail may be made without departing from the spirit and scope of the disclosure. The present disclosure is intended to embrace all such alternatives, modifications and variances. Where the disclosure recites “a,” “a first,” or “another” element, or the equivalent thereof, it should be interpreted to include one or more such elements, neither requiring nor excluding two or more such elements. Furthermore, any aspect shown or described with reference to a particular embodiment should be interpreted to be compatible with any other embodiment, alternative, modification, or variance.

We claim:

1. A carrier for a bicycle, comprising:
a first frame structure configured to couple to a vehicle;
a second frame structure configured to couple to the vehicle;
a body disposed between the first and second frame structures, the first frame structure being mounted to the body and the second frame structure being slidably received within the body; and
a first cable device including:
a first cable reel rotatably mounted to the body, and
a first cable having a first hook end portion configured to attach to a first portion of the vehicle, the first cable being configured to be wound around the first cable reel.

2. The carrier of claim 1, wherein the first cable device includes a bias element configured to urge the first cable reel to rotate in a direction that winds the first cable around the first cable reel.

3. The carrier of claim 1, wherein the first cable device includes a first locking mechanism configured to prevent rotation of the first cable reel.

4. The carrier of claim 3, wherein the first locking mechanism includes a first locking member and a first adjustment member, the first locking member being configured to move between a locking position in which the first locking member contacts the first cable reel to prevent rotation, and an unlocking position in which the first locking member is spaced from the first cable reel allowing rotation, the first adjustment member allowing a user to move the first locking member between the locking and unlocking positions.

5. The carrier of claim 4, wherein the adjustment member includes a lever.

6. The carrier of claim 1, further comprising a second cable device including:
a housing mounted to the first frame structure,
a second cable reel rotatably mounted to the housing, and
a second cable having a second hook end portion configured to attach to a second portion of the vehicle different from the first portion, the second cable being configured to be wound around the second cable reel.

7. The carrier of claim 6, wherein the second cable device includes a second locking mechanism configured to prevent rotation of the second cable reel, the second locking mechanism including a second locking member and a second adjustment member, the second locking member being configured to move between a locking position in which the second locking member contacts the second cable reel to prevent rotation, and an unlocking position in which the second locking member is spaced from the second cable reel allowing rotation, the second adjustment member allowing a user to move the second locking member between the locking and unlocking positions.

8. The carrier of claim 6, wherein the second cable device includes an adjustment mechanism configured to allow a user to rotate the second cable reel to adjust the tension of the second cable when the second hook end portion is attached to the second portion of the vehicle.

9. The carrier of claim 6, wherein the first cable device further includes a third cable reel and a third cable having a third hook end portion configured to attach to a third portion of the vehicle different from the first and second portions, the third cable being configured to be wound around the third cable reel.

10. The carrier of claim 1, further comprising at least one arm pivotably coupled to the body.

11. A method of mounting a bicycle carrier to a vehicle, comprising:
placing a first frame structure, a second frame structure, and a body disposed between the first and second frame structures of the carrier in a preliminary configuration relative to the vehicle;
slidingly translating one of the first and second frame structures relative to the other frame structure and the body to place the carrier in a configuration approximating a final configuration;
extending at least one cable having a hook end portion from at least one cable reel of the body; and
attaching the hook end portion to a portion of the vehicle to fix the carrier in the final configuration.

12. The method of claim 11, further comprising unlocking the at least one cable reel prior to the extending step.

13. The method of claim 12, further comprising locking the at least one cable reel after the attaching step.

14. The method of claim 11, further comprising adjusting tension in the cable after the attaching step.

15. The method of claim 11, wherein the extending step includes extending first and second cables from the body, the first cable having a first hook end portion and the second cable having a second hook end portion, the attaching step further including attaching the first hook end portion to a first portion of the vehicle and attaching the second hook end portion to a second portion of the vehicle different from the first portion.

16. The method of claim 15, wherein the extending step includes extending a third cable from the first frame structure, the third cable having a third hook end portion, the attaching step further including attaching the third hook end portion to a third portion of the vehicle different from the first and second portions.

17. A carrier for a bicycle, comprising:
a first frame structure having first and second end portions, the first end portion being configured to couple to a vehicle;
a second frame structure having third and fourth end portions, the fourth end portion being configured to couple to the vehicle;
a body connecting the second end portion of the first frame structure and the third end portion of the second frame structure, at least one of the second and third end portions being movably connected to the body;
a first cable device including:
a first cable spool rotatably mounted to the body,
a first cable having a first hook end portion configured to attach to a first portion of the vehicle, the first cable being configured to be received on the first cable spool; and
a second cable device including:
a housing mounted adjacent to the first end portion and spaced from the second end portion of the first frame structure,
a second cable spool rotatably mounted to the housing, and
a second cable having a second hook end portion configured to attach to a second portion of the vehicle different from the first portion, the second cable being configured to be received on the second cable spool.

18. The carrier of claim 17, wherein the first cable device further includes:
a third cable spool rotatably mounted to the body, and
a third cable having a third hook end portion configured to attach to a third portion of the vehicle different from the first and second portions, the third cable being configured to be received on the third cable spool.

19. The carrier of claim 18, wherein the body includes first and second discrete cavities, the first cable spool being rotatably mounted in the first cavity and the third cable spool being rotatably mounted in the second cavity.

20. The carrier of claim 19, wherein the first and third cable spools rotate around a common axis.
